(19) United States
(12) Patent Application Publication
(10) Pub. No.: US 2001/0003520 A1
(43) Pub. Date: Jun. 14, 2001

(54) COMPACT DISC TRANSPORT MECHANISM

(76) Inventors: ALAN JOHN CLARK, GLASGOW (GB); IVOR SIGMUND TIEFENBRUN, GLASGOW (GB); ALASTAIR JAMES MACKENZIE BROWN, GLASGOW (GB); CHRISTOPHER GEORGE MCERLEAN, GLASGOW (GB)

Correspondence Address: RATNER & PRESTIA, ONE WESTLAKES, SUITE 301, P O BOX 980, VALLEY FORGE, PA, 194820980

(21) Appl. No.: 09/145,372

(22) Filed: Sep. 1, 1998

(30) Foreign Application Priority Data
Sep. 1, 1997 (GB) 9718409.7

(51) Int. Cl. G11B 33/02

(52) U.S. Cl. 369/75.2

(57) ABSTRACT

A touch sensitive transport mechanism for an electronic apparatus such as a compact disc player. The transport mechanism has a drawer with a front push panel which can be lightly pushed by the operator. This allows the operator to directly control the operation of the electronic apparatus without the need for separate control buttons, thereby physically interacting with the electronic apparatus. A motor drives the drawer between open and closed positions. The mechanism has optical sensors which detect when the drawer is pushed, and the motor provides a feedback force against the push of the operator. When the drawer is in the closed position, a short push increments between tracks on a compact disc, an intermediate push causes playback of the compact disc to stop, and a long push causes the motor to drive the drawer to the open position.

### BACKGROUND OF THE INVENTION

The present invention relates to a touch sensitive transport mechanism for an electronic apparatus, particularly a compact disc transport mechanism. The transport mechanism according to the invention has a drawer which is touch operated and allows the operator to directly control the operation of the electronic apparatus without the need for separate control buttons, thereby physically interacting with the electronic apparatus.

Compact disc players are well known. Typically, they comprise a motorised drawer and a number of function select buttons on the front of the player. The function select buttons may be used to control the operation of the transport drawer, either opening or closing the mechanism to enable the playback of a compact disc. In addition function select buttons may be used to start and stop playback of a compact disc (CD) and to select the appropriate track on a CD for playback. Other electronic devices which use drawers for loading the data carrier are DVD players, laser disc players, computer CD-ROM drives and video and audio cassette players and recorders.

It is recognised in the present invention that the requirement of incorporating a number of function select buttons complicates operation of the compact disc player. Compact disc players commonly have a plurality of function select buttons for the various functions they are required to carry out- The number of these buttons can lead to confusion for the user and can also detract from the aesthetic appeal of the unit. In addition the user is more remote from the actual operation of the compact disc player, and the feeling of interacting with the apparatus, present in the use of hifi LP turntables when the user lifts the needle to the required track, is absent.

An object of the present invention is to reduce the number of function buttons required for operation and thus simplify operation of the unit by enabling the loading drawer to be touch operated directly by the user. A further object is to allow the operator to directly control the operation of the compact disc player or other electronic apparatus by physically interacting with the electronic apparatus.

It is a further object of the present invention to permit playback and control of the start and stop functions of the compact disc by touching the drawer, thereby making the user feel more involved with the control of the unit and enabling control requests and control actions to be coincidental.

### SUMMARY OF THE INVENTION

According to a first aspect of the invention there is provided a transport mechanism comprising a microprocessor control means, a movable loading means, a drive means adapted to guide said movable loading means between a first loading position and a second operating position, a pressure detecting means adapted to detect pressure applied to said movable loading means and to send a signal indicative of said pressure to said microprocessor control means, said microprocessor control means being adapted on receipt of said signal indicative of said pressure to send a control signal to operate said drive means, so as to move said loading means to said loading position if said loading means is in said operating position and to move said loading means to said operating position if said loading means is in said loading position.

The movable loading means may comprise a drawer for a compact disc, laser disc, DVD, audio cassette, video cassette or computer data storage device. The movement of the movable loading means may be a sliding movement or a rotational movement about a hinge axis. The loading means may comprise a panel located at the forward end of the loading means and adapted to be pressed by a person operating the transport mechanism.

Preferably the drive means comprises an electrical motor.

Preferably said switch comprises a resilient means adapted to bias the loading means against pressure on said panel. Preferably the switch is adapted to detect when the loading means is moved a predetermined distance beyond the operating position. Preferably said predetermined distance is less than 5 mm, most preferably less than 2 mm. Preferably the switch comprises an optical switch. Preferably said switch is located at the rear end of the loading means.

Preferably the control means is adapted to cause the drive means to apply a feedback force against pressure applied by an operator to the loading means.

Preferably the control means includes means for measuring the elapsed time for which the loading means is moved a predetermined distance beyond the operating position.

Preferably the control means is adapted to cause the loading means to move from said operating position to said loading position when the elapsed time reaches a predetermined time, preferably less than 3 seconds, most preferably less than 1 second.

Preferably the control means is adapted to send a signal to toggle between “play” and “stop” the elapsed time does not reach a predetermined time before the operator removes the pressure from the loading means.

According to a second aspect of the invention there is provided a data carrier reading system comprising:

a drawer for holding a data carrier, said drawer being movable between an open position and a closed position;

sensor means adapted to detect when pressure is applied to the drawer;

drive means adapted to move the drawer between the open and closed positions;

data reading means adapted to read data on the data carrier when said drawer is in the closed position; and

microprocessor control means adapted to control and drive means and data reading means and to monitor the sensor means.

The data reading means or operating means may be a data reading device or a compact disc player or similar.

Preferably the control means is adapted to move between three states, a first state in which the drawer is in an open position and the operating means is oft, a second state in which the drawer is in a closed position and the operating means is on, and a third state in which the drawer is in a closed position and the operating means is off.

Preferably the control means is adapted to move from the first state to the second state when pressure is applied to the drawer and then released.

Preferably the control means is adapted to move from the second state to the third state when pressure is applied to the drawer for a time which is less than a predetermined time and then released. Preferably the control means is adapted to move from the second state to the first state when pressure is applied to the drawer for a time which is more than said predetermined time and then released.

Preferably the control means is adapted to move from the third state to the second state when pressure is applied to the drawer for a time which is less than a predetermined time and then released. Preferably the control means is adapted to move from the third state to the first state when pressure is applied to the drawer for a time which is more than said predetermined time and then released.

Preferably the control means is adapted to operate according to the logic diagram shown in FIG. 3.

### BRIEF DESCRIPTION OF THE DRAWINGS

Other objects and advantages of the invention will become apparent upon reading the following detailed description and upon reference to the drawings in which:

FIG. 1 shows a CD player incorporating a transport mechanism according to the invention;

FIG. 2 is a schematic view of the chassis and drawer of the compact disc transport mechanism of FIG. 1;

FIG. 3 is a plan schematic view of the drawer and part of the chassis of the mechanism of FIG. 1;

FIG. 4 is an elevation of the drawer of FIG. 3, showing part of the drive mechanism;

FIG. 5 is a plan schematic view of the drawer showing the position of the optical sensors in the mechanism of FIG. 1;

FIG. 6 is an elevation of the drawer of FIG. 5, showing the optical sensors and part of the drive mechanism;

FIG. 7 is a logic diagram showing how the operation of the compact disc transport mechanism of FIG. 1 is achieved by the control system according to a first mode of operation; and

FIG. 8 is a logic diagram showing how the operation of the compact disc transport mechanism of FIG. 1 is achieved by the control system according to a second mode of operation.

### DETAILED DESCRIPTION OF THE INVENTION

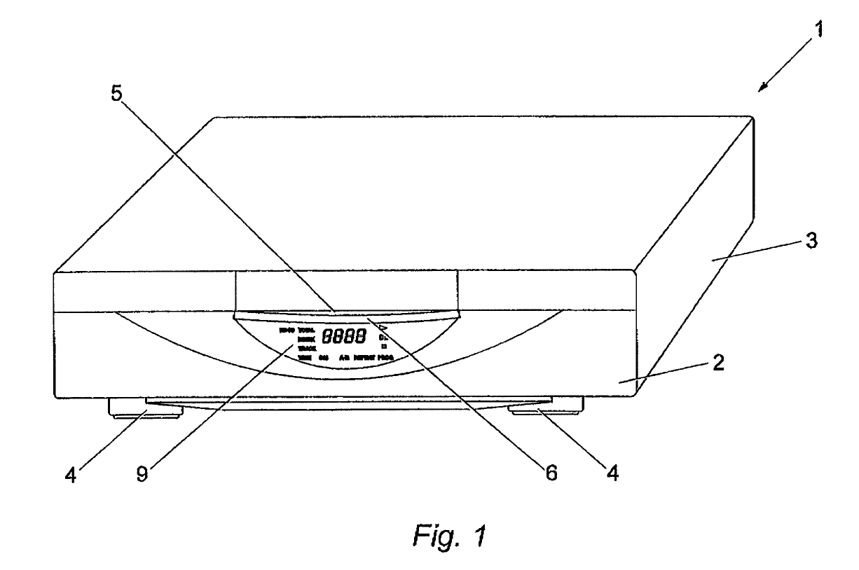

Referring to FIG. 1 there is shown a compact disc player 1 having a front panel 2 and a body 3. The player 1 is mounted on feet 4. The front panel 2 has a drawer 5 which can slide out from the front panel and forms a moveable loading means for loading a compact disc. The front edge 6 of the drawer is curved and projects forward from the front panel 2 when the drawer 5 is in the closed position, thereby forming a push panel or push surface 6 which may be readily pushed by a person operating the compact disc player. The push surface may be curved, planar or contoured in an appropriate fashion which is pleasing aesthetically and ergonomically suitable for pushing. Beneath the drawer 5 there is an illuminated display 9 which gives information on the status of the compact disc player and the playback of a disc which is played in the player 1. At the rear of the player are electrical power and audio connections (not shown).

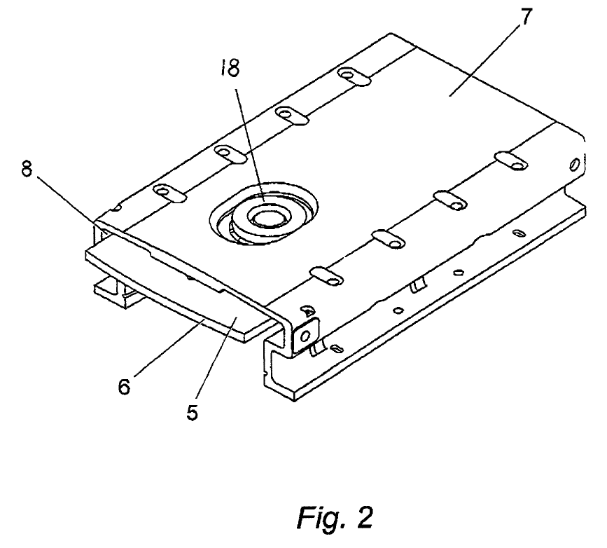

FIG. 2 shows the transport mechanism comprising the 19 is compact disc drawer 5 and the chassis or housing 7 which is mounted within the player 1 behind the front panel 2. The chassis is of cast or extruded metal or metal alloy. On one side of the chassis is a recess 8 which forms a guide rail for a guide wheel 40 mounted on the drawer 5. Also mounted within the recess are one or more pairs of guide wheels (not shown) which engage the top and bottom surface of the drawer to allow longitudinal sliding movement while preventing vertical movement of the drawer relative to the chassis.

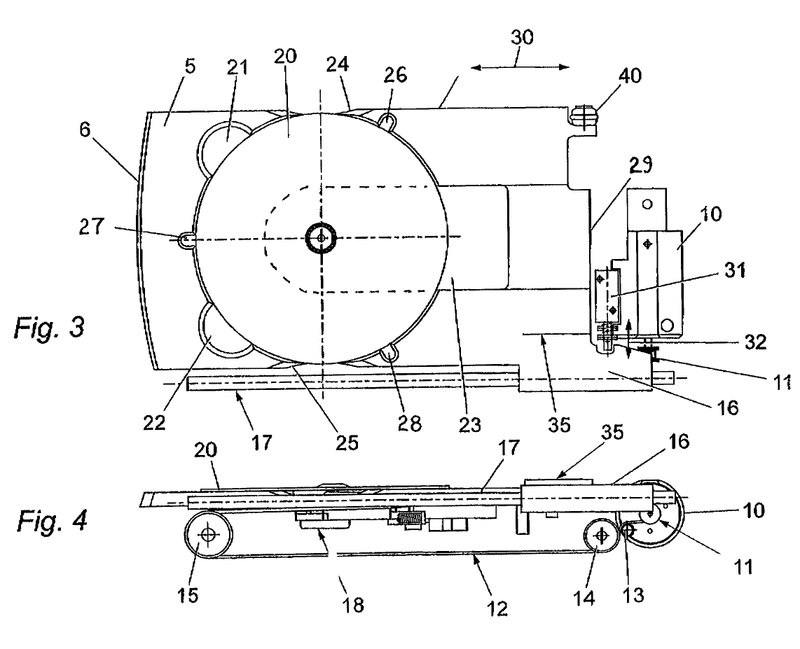

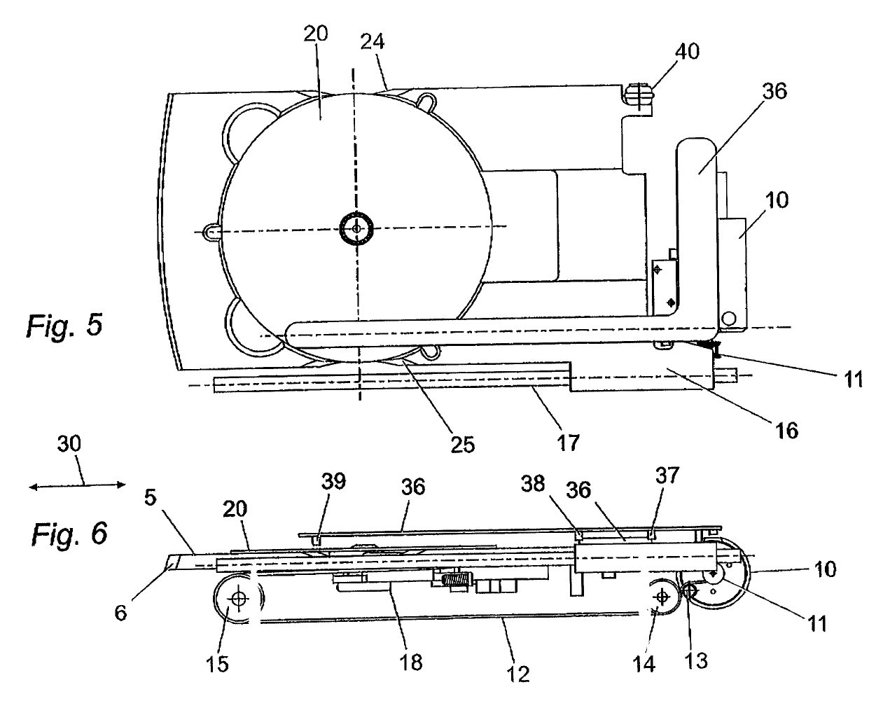

Referring to FIGS. 3 to 6, the drawer 1 is powered by a drive means comprising an ironless rotor motor 10 fixed to the chassis 7. The motor 10 drives a toothed drive pulley 11, which in turn drives a toothed drive belt 12. The drive belt 12 runs around idler pulleys 13, 14, 15 and is fixed to the drawer by any appropriate means, such as a screw clamp (not shown). The motor 10 has an integral tachometer (not shown) and is controlled by a preprogrammed microprocessor control unit (not shown) which accurately controls the speed of the motor and hence the speed of the drawer 5. The drawer 5, which is made of cast or extruded metal or metal alloy, has a projecting lug 16 on one side a provided with a longitudinal bore which fits around a guide rod 17 fixedly mounted in the chassis 7. The other side of the drawer has a roller 40 rotatably mounted on the drawer. This roller engages with the upper and lower surfaces of the recess 8 in the chassis when the drawer moves longitudinally, to support B drawer 5 and prevent it from vertical movement relative to the chassis 7.

The upper surface of the drawer 5 is similar to known CD drawers and has a circular recess in which is placed a CD 20, so that during transport of the drawer the CD is below the upper surface of the drawer. So that the CD does not sit directly on the metal drawer surface, there are provided three rubber pads 26, 27, 28 on which the CD sits, Two circular holes 21, 22 (partly obscured by the CD 20) are provided in the drawer to allow a CD to be placed in the drawer and picked up by hand at its edges. Chamfered recesses 24 and 25 in the side of the drawer 5 also aid removal of the CD 20 when the drawer is open Beneath the CD drawer is a laser assembly 18 for reading the data on the CD in a conventional manner. When the CD 20 is played the assembly accesses the CD through a cut-out 23 in the drawer and lifts the CD 20 off the pads 26, 27, 28 so that the CD projects above the top face of the drawer, adopting the position shown in FIG. 4. When the drawer moves from the closed position to the open position the laser assembly, which is mounted on a separate sub-chassis,, drops away from the drawer, allowing the CD 20 and drawer 5 to slide open. The operation of the laser assembly is not described further, since it is not the subject of the invention.

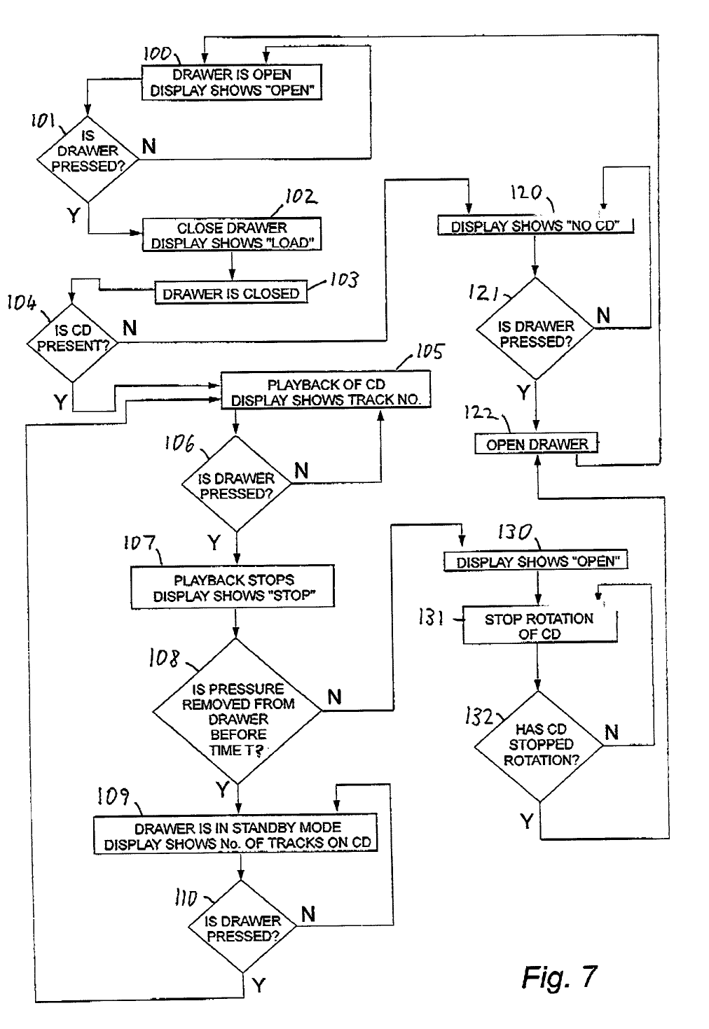

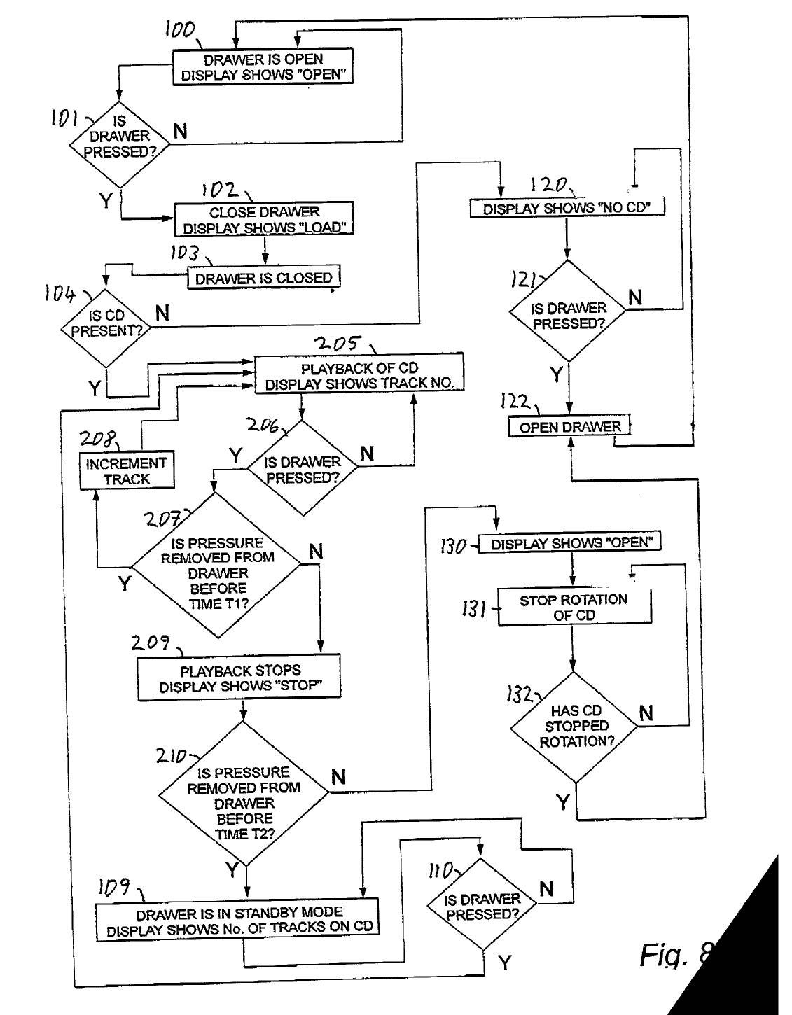

The motor 10 is operated by a microprocessor (not shown) to move the drawer 5 in and out in the direction of arrow 30 guided by guide rods 3 between an pen or loading position and a closed or operating position. The operation of the drawer is controlled by software programmed into the microprocessor control unit, which controls the operation of the drawer in accordance with the flow charts of FIGS. 7 and 8.

A series of optical switches are used to sense the position of the drawer 5. A drawer position flag 35 is mounted on the upper surface of the drawer 5. Fixed to the chassis above the drawer is a printed circuit board (PCB) 36 on which are mounted three optical sensors 37, 38, 39. The first sensor 37 detects when the drawer is in a closed position and is pressed at the front of the drawer to “nudge” the drawer. The nudging of the drawer causes the flag 35 to break the optical signal of sensor 37 and to send a DRAWER IS PRESSED signal to the microprocessor control. The second sensor 38 detects when the drawer is in a closed position. When the drawer is almost closed the flag 35 still breaks the optical signal of sensor 38, but when the drawer is fully closed the signal is unbroken and the sensor 38 sends a DRAWER IS CLOSED signal to the microprocessor control. When the drawer is opened the motor continues to open the drawer until the flag 35 breaks the optical signal of sensor 39, which sends a DRAWER IS FULLY OPEN signal to the microprocessor control.

The player 1 is operated by pressing on the front 6 of drawer 5. If the drawer is closed, then the pressure causes the drawer to move inwardly and close the nudge sensor 37 which in turn causes the motor 10 to provide additional “feedback” force, which is felt by the person operating the device The motor 10 and microprocessor control act as an electronic spring to provide a resilient force which acts against the force applied by the operator to the front 6 of the drawer. The digital display will display the word “OPEN” and, after the operator has released the pressure on the front of the drawer 1, thus opening the nudge sensor 37, the solenoid 31 (described later) will unlock the drawer and the motor will push the drawer 5 out to an open position, in which a compact disc 20 can be inserted onto the drawer 5.

Because the apparatus does not rely on a spring to provide resilient reaction force, the software can be adapted to control the motor, so as to provide a clearly discernible reaction force when the operator pushes the front of the drawer. However it is possible to provide a spring of relatively low stiffness to provide additional reactive force against pressure applied to the drawer to move it to the nudge position. Such a spring may be mounted adjacent to the motor 10 so as to bear on the rear edge 29 of the drawer 5. The spring is adjusted such that there is no reaction force on the drawer 5 when the drawer is in the closed position, but movement of the drawer backwards due to pressure on the front push surface 6 will cause the spring to bear on the rear edge 29 and to impart a resilient reaction force at the rear of the drawer 5.

When the drawer 5 is in the open position, a compact disc 20 may be placed in the drawer S. Another press on the front 6 of the drawer will open optical sensor 39 and send a signal to engage the motor to close the drawer 5. When the drawer 5 is fully closed, as monitored by optical sensor 38, a spring-loaded solenoid 31 is triggered by the microprocessor 5 to move in the direction of arrow 32 such that a locking pin 33 engages in a corresponding recess 34 in the drawer 5. The pin 33 serves to lock the drawer 5 in place to prevent movement during playback, although the recess is of a size which permits a small amount of nudge movement.

The optical sensors 37, 38, 39 and microprocessor control thus act as a pressure detecting means to detect when pressure is applied to the front 6 of the drawer.

The compact disc player may be operated in one of two modes. In a first mode, illustrated by the flow chart of FIG. 7, while the compact disc 20 is being played a brief press on the front 6 of the drawer will stop the playback, and “STOP” will be displayed on the display 9. Another brief press on the drawer front 6 will begin the playback of the disc again, with “PLAY” now being displayed on the display 9. In each case, if the brief press is longer than a predefined time T (typically half a second or so), the software will register this and cause the drawer to move out, once the pressure on the drawer has been removed and once the compact disc has stopped rotating.

In greater detail the operation of the microprocessor control in the mode of FIG. 7 is as follows. When the drawer 5 is open, the player is in the “open” state 100 and the display 9 shows “OPEN” If the drawer 5 is pressed 101 the display 9 shows “LOAD” 102 and the drawer closes 10. If a CD is present 104, the player is in the “playback” state 105, playback commences 105 and the display 9 shows the number of the track being played. If a CD is not present 104, the display 9 shows “NO CD” 120 and waits for the drawer to be pressed again 121. When the drawer is pressed the drawer opens 122 and the player reverts to the open state 101.

When the player is in the “playback” state 105, if the drawer is pressed 106 an elapsed time counter starts and playback stops, with the display 9 showing “STOP” 107. It pressure is removed from the drawer before the elapsed time reaches predetermined time T 108, then the player enters the “stop” or “standby” state 109. The player reverts to the “playback” state 105 when the drawer is pressed again 110. If pressure is not removed from the drawer before the elapsed time reaches predetermined time T 108, then the display 9 shows “OPEN” 130, rotation of the CD stops 131 and after the microprocessor has checked that the CD has stopped rotating completely 132, the drawer opens 122 and the player enters the “open” state 100.

In a second mode, illustrated by the flow chart of FIG. 8, the player will start playing a CD at track one. While the compact disc 20 is being played, a brief press on the front 6 of the drawer will cause the CD player to skip or increment to the start of the next track, and the display 9 will show the new track number. By rapidly repeated short presses the user can increment by a number of tracks- If the user holds the drawer front 6 pressed for a longer period, longer than a first predetermined time T1, until the word “STOP” or an equivalent symbol appears in the display 9 and/or an audible signal is given, then the microprocessor control will stop the playback. Another brief press on the drawer front 6 will begin the playback of the disc again, with “PLAYs now being displayed on the display 9. However, if the drawer front continues to be pressed for an even longer period, longer than a second predetermined time T2, until the word “OPEN” or an equivalent symbol appears in the display 9 and/or second audible signal is given, then the microprocessor control will cause the drawer to move out, once the pressure on the drawer has been removed and once the compact disc has stopped rotating.

In greater detail the operation of the microprocessor control in the mode of FIG. 8 is very similar to that of FIG. 7, and the same steps in the flow chart have is the same reference numerals in FIGS. 7 and 8. as follows. When the player is in the “playback” state 205, if the drawer is pressed 206 an elapsed time counter starts. If pressure is removed from the drawer before the elapsed time reaches predetermined time T1 207, then the player increments by one the number of the track being played 208. The player returns to the “playback” state 205 and displays the incremented track number. If pressure is not removed from the drawer before the elapsed time reaches predetermined time T1 207, then playback stops, with the display 9 showing “STOP” 209. If pressure is removed from the drawer before the elapsed time reaches a second predetermined time T2 108, where T2 is greater than T1, then the player enters the “stop” or “standby” state 109. The player reverts to the “playback” state 205 when the drawer is pressed again 110. If pressure is not removed from the drawer before the elapsed time reaches predetermined time T2 210, then the display 9 shows “OPEN” 130, rotation of the CD stops 131 and after the microprocessor has checked that the CD has stopped rotating completely 132, the drawer opens 122 and the player enters the “open” state 100.

The microprocessor control may be programmed to perform other functions in addition to those shown in the flow diagrams of FIGS. 7 and 8 and described above. For example, if the drawer 5 is left open for longer than a predetermined time, typically 2 minutes, the drawer will be closed. The motion of the drawer 5 may be programmed such that the drawer accelerates over the first part of its travel and decelerates over the last part of its travel. The player 1 may incorporate an infra red receiver in the display panel 9 so that it can function as a conventional CD player if controlled by an infra red transmitter, of the conventional type.

These and other modifications and improvements can be incorporated without departing from the scope of the invention. In particular, the invention may be applied to devices other than CD players, such as DVD players, laser disc players, computer disc drives, audio and video cassette players and recorders.

What is claimed is:

1. A transport mechanism comprising a microprocessor control means, a movable loading means, a drive means adapted to guide said movable loading means between a first loading position and a second operating position, a pressure detecting means adapted to detect pressure applied to said movable loading means and to send a a signal indicative of said pressure to said microprocessor control means, said microprocessor control means being adapted on receipt of said signal indicative of said pressure to send a control signal to operate said drive means, so as to move said loading means to said loading position if said loading means is in said operating position, and to move said loading means to said operating position if said loading means is in said loading position.

2. A transport mechanism according to claim 1, wherein said movable loading means comprises a drawer for a digital data disc.

3. A transport mechanism according to claim 1, wherein said movable loading means comprises a drawer for an audio cassette or video cassette.

4. A transport mechanism according to claim 1, wherein said loading means comprises a push plate located at a forward end of the loading means and adapted to be pressed by a person operating the transport mechanism.

5. A transport mechanism according to claim 1, wherein said pressure detecting means comprises a switch adapted to detect when the loading means is moved a predetermined distance beyond the operating position.

6. A transport mechanism according to claim 5, wherein the switch comprises an optical switch.

7. A transport mechanism according to claim 1, wherein said drive means comprises an electric motor coupled to said microprocessor control unit and a drive belt linking said moveable loading means and said motor.

8. A transport mechanism according to claim 1, wherein said microprocessor control means is adapted to cause the drive means to apply a feedback force against pressure applied by an operator to the loading means.

9. A transport mechanism according to claim 5, wherein said microprocessor control means includes means for measuring the elapsed time for which the loading means is moved a predetermined distance beyond the operating position.

10. A transport mechanism according to claim 9, wherein said microprocessor control means is adapted to cause the loading means to move from said operating position to said loading position when the elapsed time reaches a predetermined time.

11. A data carrier reading system comprising:
a drawer for holding a data carrier, said drawer being movable between an open position and a closed position;
sensor means adapted to detect when pressure is applied to the drawer;
drive means adapted to move the drawer between the open and closed positions;
data reading means adapted to read data on the data carrier when said drawer is in the closed position; and
microprocessor control means adapted to control the drive means and data reading means and to monitor the sensor means.

12. A system according to claim 11 wherein the control means is adapted to move between three states, an open state in which the drawer is in an open position and the data reading means is off, a playback state in which the drawer is in a closed position and the data reading means is on, and a stop state in which the drawer is in a closed position and the data reading means is off.

13. A system according to claim 12 wherein the control means is adapted to move from the open state to the playback state when the sensor means senses that pressure is applied to the drawer and then released.

14. A system according to claim 13 wherein the control means is adapted to move from the playback state to the stop state when the sensor means senses that pressure is applied to the drawer for a time which is less than a first predetermined time and then released.

15. A system according to claim 14 wherein the control means is adapted to move from the playback state to the open state when the sensor means senses that pressure is applied to the drawer for a time which is more than said first predetermined time.

16. A system according to claim 15 wherein the control means is adapted to move from the stop state to the playback state when the sensor means senses that pressure is applied to the drawer for a time which is less than said first predetermined time and then released.

17. A system according to claim 16 wherein the control means is adapted to move from the stop state to the open state when the sensor means senses that pressure is applied to the drawer for a time which is more than said first predetermined time.

18. A system according to claim 11 wherein~said data carrier reading system is a compact disc player, said data carrier is a compact disc and said data reading means is a laser assembly.

19. A compact disc player comprising:
a drawer for holding a compact disc having data thereon arranged in a plurality of incrementally numbered tracks, said drawer being slidable between an open position and a closed position;
an optical sensor adapted to detect when pressure is applied to the drawer such as to move said drawer;
a motor adapted to move the drawer between the open and closed positions;
a laser reading assembly adapted to read data on the compact disc when said drawer is in the closed position, said assembly being switchable between on and off states; and
microprocessor control means adapted to control the motor and laser assembly and to monitor the optical sensor.

20. A compact disc player according to claim 19 wherein the control means is adapted to move between three states, an open state in which the drawer is in an open position and the laser reading assembly is off, a playback state in which the drawer is in a closed position and the laser reading assembly is on, and a stop state in which the drawer is in a closed position and the laser reading assembly is off.

21. A compact disc player according to claim 20 wherein the control means is adapted to move from the open state to the playback state when the optical sensor senses that pressure is applied to the drawer and then released.

22. A compact disc player according to claim 21 wherein the control means is adapted to cause the laser reading assembly to read data from a track having a number one higher than the track presently being read when the control means is in the playback state and the optical sensor senses that pressure is applied to the drawer for a time which is less than a second predetermined time and then released.

23. A compact disc player according to claim 22 wherein the control means is adapted to move from the playback state to the stop state when the optical sensor senses that pressure is applied to the drawer for a time which is more than said second predetermined time but less than a third predetermined time and then released.

24. A compact disc player according to claim 23 wherein the control means is adapted to move from the playback state to the open state when the optical sensor senses that pressure is applied to the drawer for a time which is more than said third predetermined time.

25. A compact disc player according to claim 24 wherein the control means is adapted to move from the stop state to the playback state when the optical sensor senses that pressure is applied to the drawer for a time which is less than said second predetermined time and then released.

26. A compact disc player according to claim 25 wherein the control means is adapted to move from the stop state to the open state when the optical sensor senses that pressure is applied to the drawer for a time which is more than said second predetermined time.
